(19) United States
(12) Patent Application Publication
(10) Pub. No.: US 2004/0057503 A1
(43) Pub. Date: Mar. 25, 2004

(54) Method and apparatus for processing a composite signal including a desired spread spectrum signal and an undesired narrower-band interfering signal

(75) Inventor: Brian Todd Kelley, Austin, TX (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/253,628

(22) Filed: Sep. 24, 2002

(51) Int. Cl. H04B 1/69

(52) U.S. Cl. 375/148

(57) ABSTRACT

A method and apparatus (400) process a composite signal (202) comprising a spread spectrum signal and an interfering signal (204) to determine the center frequency of the interfering signal, and to shift the composite signal by an amount determined from the characteristic frequency of the interfering signal, thereby creating a shifted composite signal (146) in which the frequency of the interfering signal is a predetermined frequency. The method and apparatus then filters the shifted composite signal to remove the interfering signal, thereby creating an interference-free shifted signal (148), and reshifts the interference-free shifted signal by the amount determined from the characteristic frequency of the interfering signal, thereby recovering the desired spread spectrum signal.

### FIELD OF THE INVENTION

This invention relates in general to communication systems, and more specifically to a method and apparatus for digitally processing a composite signal such as a desired spread spectrum signal and an undesired narrower-band interfering signal.

### BACKGROUND OF THE INVENTION

In spread spectrum communications, the signals of interest are spread over a wide frequency range. This may result in superior noise immunity, improved system capacity, and improved signal integrity at the receive antenna. Unfortunately, wide-band signaling also increases the likelihood that the wireless communications physical channel will encounter spurious narrow-band interfering signals. This can occur as a result of either over-the-air interference or nonlinearities associated with analog components used in the end-to-end communications system.

In modern digital communications systems, the analog-to-digital converter is moving ever closer to the antenna to enable the use of Digital Signal Processing (DSP) techniques as close as possible to the signal capture point in the receiver. This has lead to a desire to implement entirely digital cancellation techniques for narrow-band interference in spread spectrum signals. Unfortunately, the high sampling rate associated with spread spectrum signals has implied high rate multiplication operations, specialized multiplication hardware, and extraordinarily high computational requirements for prior-art adaptive nulling techniques, such as the Least Means square (LMS) and the Recursive Least Squares (RLS) techniques. Furthermore, there has been an added complexity for properly tracking a time-varying frequency spur.

Thus, what is needed is a method and apparatus for digitally processing a composite signal such as a desired spread spectrum signal and an undesired narrow-band interfering signal. Preferably the processing will not require high rate multiplication operations.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an electrical block diagram of an exemplary first embodiment of an apparatus.

FIG. 2 is a frequency-domain diagram depicting the magnitude over frequency of an exemplary composite signal.

FIG. 3 is an electrical block diagram of an exemplary second embodiment of an apparatus.

FIG. 4 is an electrical block diagram of an exemplary third embodiment of an apparatus.

FIG. 5 is a frequency-domain diagram depicting the magnitude over frequency of an exemplary shifted composite signal.

FIG. 6 is a frequency-domain diagram depicting the magnitude over frequency of an exemplary interference-free shifted signal.

FIG. 7 is a frequency-domain diagram depicting the magnitude over frequency of an exemplary recovered spread spectrum signal.

FIG. 8 is a communication device at least partially in block diagram form.

### DETAILED DESCRIPTION OF THE PREFERRED EMBODIMENTS

In overview form the present disclosure concerns communications systems that utilize receivers to provide service for communications units or more specifically a user thereof operating therein. More particularly, various inventive concepts and principles embodied as methods and apparatus for processing a composite signal including, for example, a desired spread spectrum signal and an undesired narrow-band interfering signal for use in equipment with such communications systems will be discussed and disclosed. The communications systems of particular interest are those being deployed and developed such as CDMA (Code Division Multiple Access), W-CDMA (Wideband-CDMA), CDMA2000, 2.5G (Generation), 3G, UMTS (Universal Mobile Telecommunications Services) systems and evolutions thereof that utilize spread spectrum signals, although the concepts and principles have application in other systems and devices, such as modems.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in one or more conventional digital signal processors (DSPs), or with integrated circuits (ICs) such as custom or application specific ICs. It is expected that one of ordinary skill, notwithstanding possibly significant effort and many design choices motivated by, for example, available time, current technology, and economic considerations, when guided by the concepts and principles disclosed herein will be readily capable of programming such DSPs, or generating such ICs with minimal experimentation. Therefore, in the interest of brevity and minimization of any risk of obscuring the principles and concepts according to the present invention, further discussion of such DSPs and ICs, if any, will be limited to the essentials with respect to the principles and concepts employed by the preferred embodiments.

Referring initially to FIG. 8, a noise canceling apparatus 100, 300, 400 includes a Digital Phase Locked Loop (PLL) 808 that receives from an analog-to-digital converter 804, digital I and Q representations of the a wide spectrum signal including a high amplitude noise signal. Such interfering signals may, for example be of the type commonly referred to by those skilled in the art as a “jammer signal”. Digital PLL 808 outputs a characteristic frequency, which may be, for example, the center or strongest frequency, of the jammer signal. A filter 810 is connected to receive the output of the PLL 808, and outputs a smoothed representation of the characteristic frequency from the PLL 808. The frequency is converted to a phase in a frequency to phase converter 812.

A frequency shifter 814 shifts the I and Q signals output by the A/D converter by an amount proportional to the characteristic frequency of the interfering signal, such that the characteristic frequency is at a predetermined value. For example, the characteristic frequency may advantageously be the center frequency, and the predetermined value may be zero Hz (DC). A DC notch filter 816 removes the DC component output by the frequency shifter 814, to remove the interfering signal. A shifter 818 receives the filtered output, and shifts this output signal, with the interfering signal removed, back to its frequency prior to shifting in shifter 814.

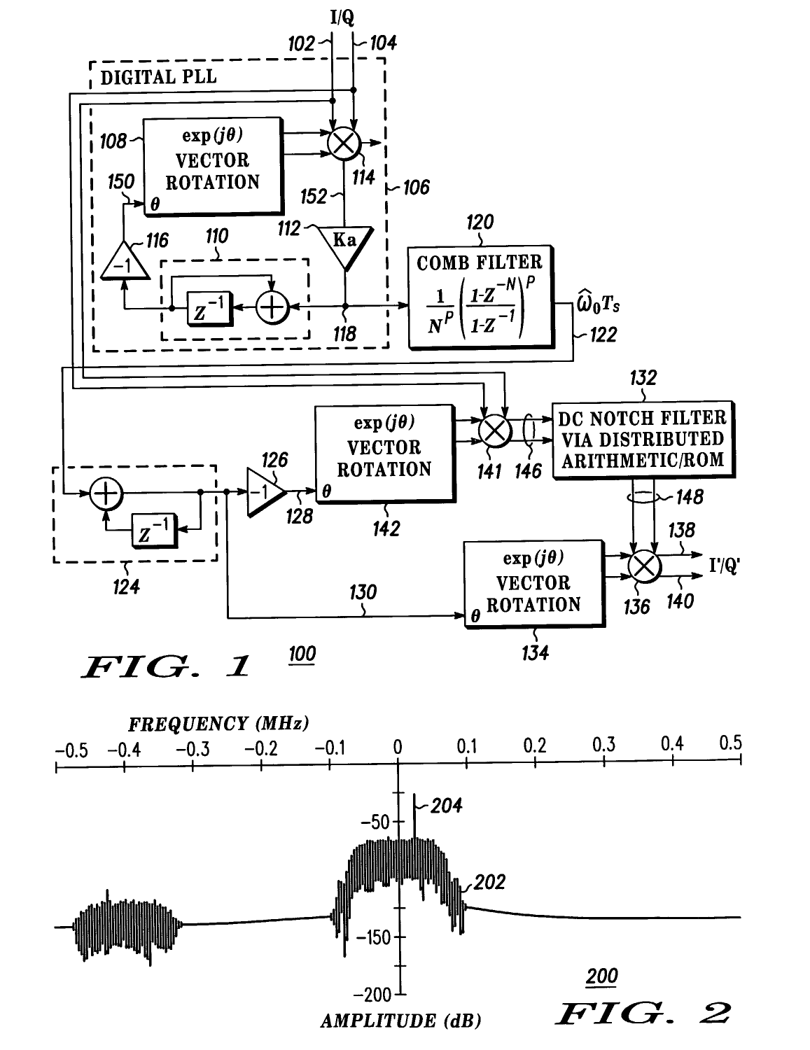

Referring to FIG. 1, an electrical block diagram of an exemplary first embodiment of an apparatus 100 comprises an adaptive Digital Phase Locked Loop (PLL) 106, two complex mixers 141 and 136, a comb, i.e., sinc(f) based, filter 120, and a DC notch filter 132. The first embodiment 100 is an equivalent model with the same resulting functional operation as the preferred embodiment and is included for less complex conceptualization. The input to the first embodiment 100 at input nodes 102, 104 is a generic wide-band frequency signal plus additive narrow-band noise at a frequency of ^{ω}0. Note that the input signal can be viewed as a complex time varying input signal of the form I(t)+jQ(t). Alternatively, at any specific time instance, ti, the signal can be viewed as a complex valued number of the form I+jQ (i.e., I(t=ti)+jQ(t=ti)).

The PLL 106 comprises a conventional gain block 112 coupled to the real output 152 of a first conventional complex mixer 114, which mixes the complex input signal with the complex output of a first conventional complex exponent function generator 108 for vector rotation. The output 118 of the gain block 112 is coupled to a conventional integrator 110, which is coupled through a conventional negating stage 116 to generate a control signal 150 representing a phase input for the first complex exponent function generator 108. The output 118 of the digital PLL 106 locks on to the center frequency of the narrow-band interferer.

FIG. 2 is a frequency-domain diagram 200 depicting the magnitude over frequency of an exemplary composite input signal 202. As illustrated, the undesired narrow-band interfering signal is a complex noise tone 204 at a frequency of fc+25 KHz, where fc represents the carrier frequency. In other words, the interfering signal is 25 KHz above the carrier frequency. In the examples that follow, we choose a signal bandwidth of 100 KHz, a sampling rate of 1 MHz, and a carrier frequency of 200 KHz.

The first embodiment 100 works as follows. In spread spectrum signaling, the information-bearing signal is spread in frequency. The modulated signal therefore has a much wider bandwidth than the information-bearing signal. In addition, the spread spectrum data is treated as background noise by the digital PLL. Thus, the digital PLL 106 locks adaptively onto the center frequency of the complex tone 204, which in this example is at carrier frequency +25 KHz. Stability of the loop is guaranteed for loop constants satisfying the equation, 0≦Ka≦2/A, where A is amplitude of the complex tone. Let Tₛ represent a time interval between data samples (i.e., the inverse of the sampling frequency) and \hat{ω}ᵢₙₛₜ represent the instantaneous frequency value generated by the digital PLL. The value of the signal generated at the output of the loop gain block 112 is equal to \hat{ω}ᵢₙₛₜ^{T}ₛ. This signal is noisy due to the background noise associated with the spreading function of the information-bearing signal. Its DC component represents the best estimate of the center frequency of the interfering signal. For this reason, we filter this signal, preferably with a conventional M-order comb low pass Finite Impulse Response (FIR) filter 120. Though we are not restricted in the type of low-pass filter chosen, we have chosen a comb filter due to its simplicity of implementation and its circumvention of expensive high rate multiplication operations. We note that the filter is not required to be a FIR filter, since linear phase is unnecessary. Therefore, an acceptable alternative can be a low-pass Infinite Impulse Response (IIR) filter with coefficients preferably chosen according to optimum canonical sign digit representation. The smoothed output at the filter output 122 is indicated as the filtered center frequency estimate of the interfering signal, \hat{ω}₀^{T}ₛ, in FIG. 1.

The estimated interference frequency is then converted to phase via a conventional first-order integrator section 124. The integrator 124, may for example be implemented using a twos complement binary, rollover adder such that phase limiting is also provided. The determined phase is negated in a conventional negating stage 126 so that both the negative and positive phases are output from the integrator section as control signals 128 and 130, respectively. The negative phase represents the input argument to a second conventional complex exponent function generator 142 for vector rotation. The output of this function generator represents a second complex injection frequency, which is mixed with the original complex input signal in a second complex mixer 141. This effectively mixes the data to baseband, centered on the frequency of the narrow-band interferer, through a lossless, complex frequency shift, thereby producing a shifted composite signal 146 in which the center frequency of the interfering signal is zero, or DC. This shifted composite signal is filtered with a conventional fixed finite impulse response (FIR) DC notch filter 132 to remove the interfering signal, thereby producing an interference-free shifted signal 148.

Utilizing a fixed FIR filter response provides advantages of simplification. When the FIR direct current (DC) notch filter 132 is arranged to have a larger bandwidth than the largest interferer, the coefficients for the notch filter can be pre-computed and stored in memory. In this instance, distributed arithmetic, which circumvents the need for a multiplication operation, preferably is used to perform the notch filter operation. For the case where the notch filter bandwidth varies with signaling conditions, pre-computing several FIR filters of varying bandwidths is suggested. Computation of each filter can be likewise implemented via distributed arithmetic.

Finally, the interference-free shifted signal 148 is mixed in a third complex mixer 136 with a third complex injection frequency signal from a third complex exponent function generator 134 whose phase magnitude input is identical to that of the second complex exponent function generator 142, but of opposite sign. The output nodes 138, 140, coupled from the third complex mixer 136, represent a signal in which the desired spread spectrum signal has been recovered or reconstructed with the undesired narrow-band interferer substantially removed.

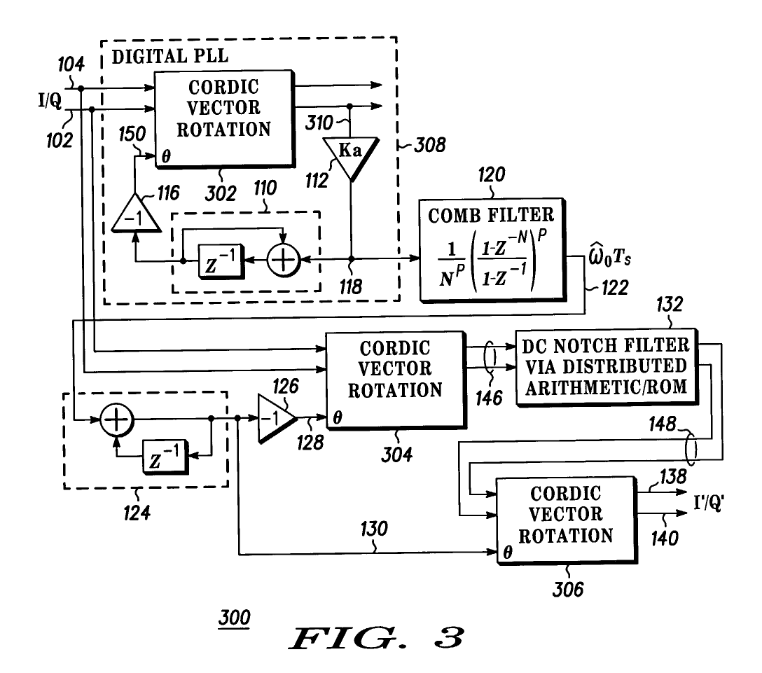

Referring to FIG. 3, an electrical block diagram of an exemplary second embodiment of an apparatus 300 is similar to the first embodiment 100, the essential difference being that the complex exponent function generators 108, 142, 134 and the complex mixers 114, 141, 136 have been replaced by first, second and third vector rotation elements 302, 304, 306, which employ the well-known Coordinate Rotation Digital Computer (CORDIC) algorithms to perform the complex mixing operation. These are a class of shift-add algorithms for rotating vectors in a plane. Briefly, the CORDIC rotator performs a rotation using a series of specific incremental rotation angles selected so that each is performed by a shift and add operation. Rotation of unit vectors provides a way to compute trigonometric functions, as well as the magnitude and phase angle of an input vector. Vector rotation is also useful in many DSP applications including modulation and Fourier Transforms. A more comprehensive discussion of CORDIC techniques may be found in A Survey of CORDIC Algorithms for FPGAs, by Ray Andraka, FPGA '98, Proceedings of the 1998 ACM/SIGDA Sixth International Symposium on Field Programmable Gate Arrays, Feb. 22-24, 1998, Monterey, Calif. pp 191-200.

The real output 310 of the first vector rotation element 302 is coupled to the gain block 112. The PLL 308 also has received a new reference number to reflect the new CORDIC vector rotation element 302 therein. CORDIC advantageously is a multiplier-free algorithm as indicated above. The input to the CORDIC element is a phase, θ, and complex data of the form I+jQ. The output from the CORDIC element is a complex signal representing the vector rotation of the input signal (i.e. I+jQ<θ). Therefore, by further constraining the digital PLL loop gain to be a power of two (i.e. 2ⁱ), no multiplication operations are required throughout the entire second embodiment 300.

Those skilled in the art will recognize that the phase integration modulo operation necessary for stable implementation can be obtained by normalizing the CORDIC with an exact same rotation functionality under the phase mapping [−2π→2π] [symbol] [−1 →1]. Thus, we scale the phase value by 1/2π. Note that vector rotation occurs identically to that of the second embodiment 300, except for the conversion of radians to normalized radians. To avoid multiplication, we implement the 1/2π scaling operation by canonical sign digit shifts and adds. Note that the comb filter and digital PLL loop are now arranged to operate with the scaled frequency value of ^{\hat{ω}}^{ᵢₙₛₜ}^{T}s/2π. However in every case, the 1/2π scaling is consumed by the normalized CORDIC algorithm and does not affect the PLL loop gain or the injection frequency result. The modulo addition operation is preferably implemented by performing the additions via twos complement fraction arithmetic and by allowing the twos complement adder to overflow above 1 and below −1.

FIG. 4 depicts another embodiment of an interference attenuator apparatus 400. The embodiment 400 is similar to the second embodiment 300, the essential difference being that the first, second, and third vector rotation elements 302, 304, 306 have been replaced by first, second, and third normalized vector rotation elements 402, 404, 406, using the [−2π→2π] [symbol] [−1 →1] phase mapping described above. In addition, 1/2π phase normalization element 410 has been inserted in the PLL 408 between the gain block 112 and the output 118.

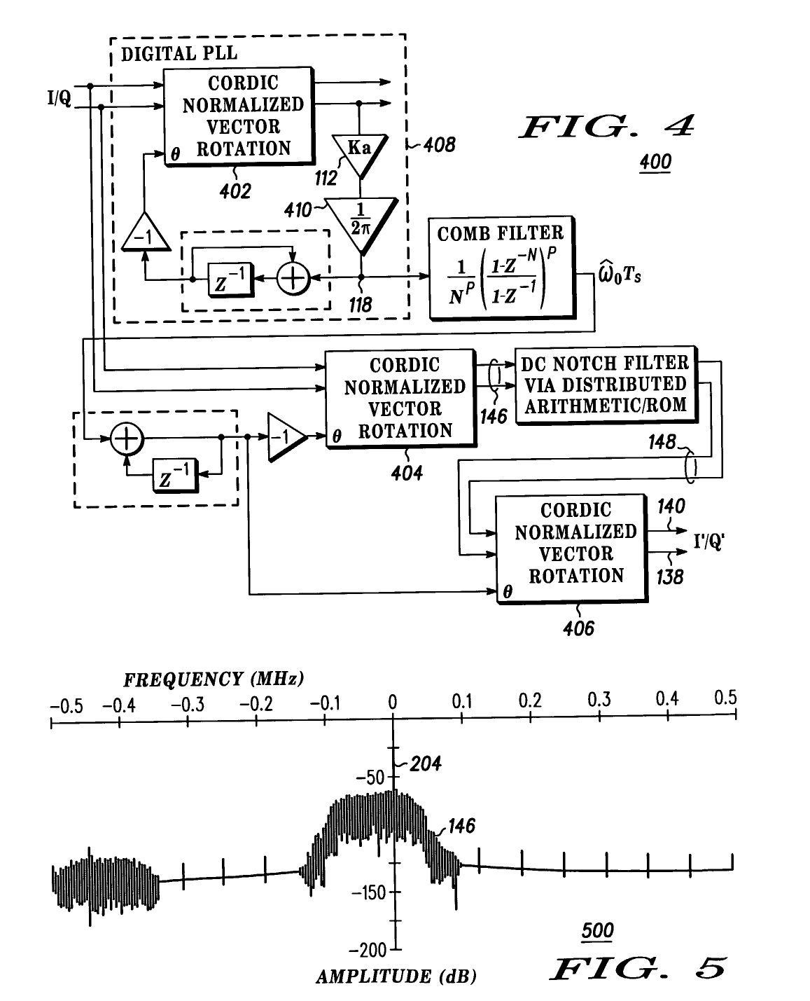

Referring to FIG. 5, a frequency-domain diagram 500 depicts the magnitude over frequency of the shifted composite signal 146. The interfering signal 204 has been moved to a predetermined frequency location, namely DC.

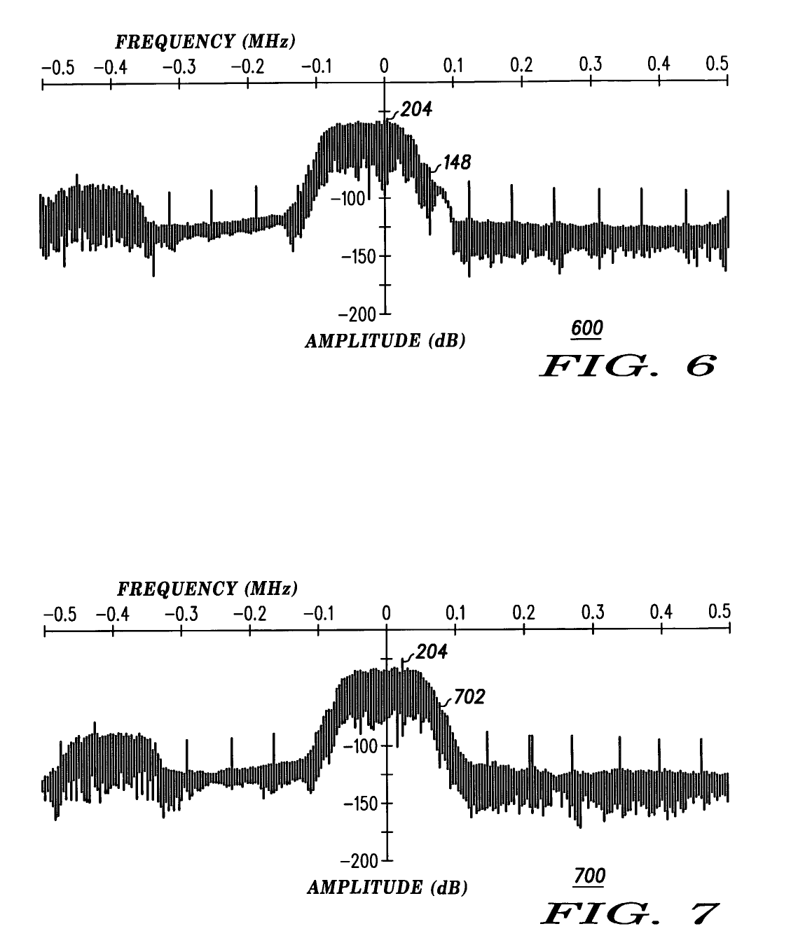

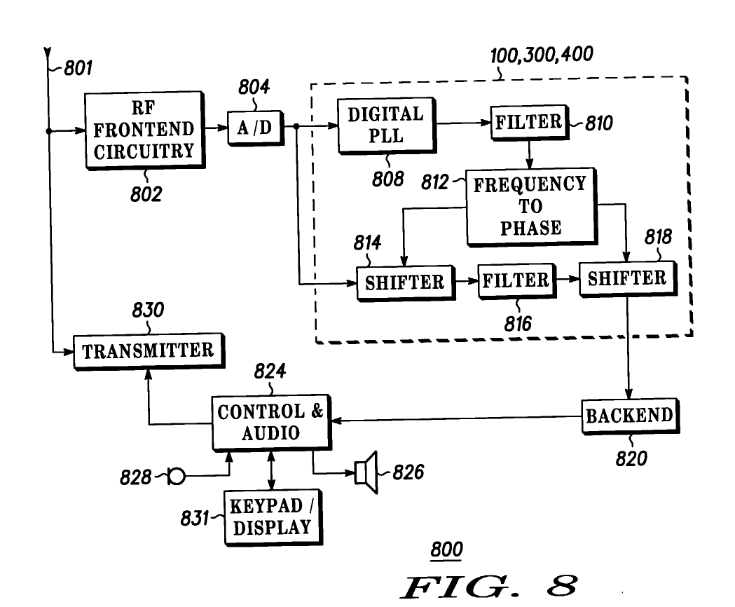

Referring to FIG. 6, a frequency-domain diagram 600 depicts the magnitude over frequency of the interference-free shifted signal 148. The interfering signal 204 has been substantially attenuated. Referring to FIG. 7, a frequency-domain diagram 700 depicts the magnitude over frequency of recovered spread spectrum signal 702 at the output nodes 138, 140. The interfering signal 204 has been effectively removed.

A communication device 800 is illustrated in FIG. 8. The communication device includes an antenna 801 through which communication signals are transmitted and/or received with another communication device (not shown), such as a base station, two-way communciation device, local area network, or the like. The communication device 800 includes conventional receiver RF front-end circuitry 802 for receiving and down-converting a wireless signal carrying the composite signal 202 and producing an analog output signal. The analog signal is converted to a digital signal in analog-to-digital (A/D) converter 804. The output of the A/D converter 804 is processed in an interference removing apparatus 100, 300, 400 for removing narrower frequency, high amplitude, interfering noise signals. The interference removing apparatus may employ any of the apparatus, 100, 300 or 400 as described hereinabove. The output of the interference removing apparatus can be processed in conventional receiver backend circuitry 820. Those skilled in the art will recognize that such circuitry typically includes equalizers, decoders, filters, and other elements. In typical devices, the backend circuitry must either employ very complex systems for detecting and removing the jammer signal, or the jammer signal must be tolerated. The present invention, improves over the prior art, by removing the jammer signal without requiring the complex operations.

The signals output from the receiver backend are input to conventional control and audio circuitry 824 of the device. It will be appreciated that the communication receiver 800 can comprise conventional elements (some of which are not shown), such as a speaker 826, a microphone 828, a display and/or keypad 831, control buttons, and/or a battery, for example. A conventional transmitter 830 is provided to support two-way communications, in conjunction with the other elements of the communication device 800.

Thus, it should be clear from the preceding disclosure that the present invention provides a method and apparatus for digitally processing a composite signal including a desired spread spectrum signal and an undesired narrow-band interfering signal. The method and apparatus advantageously nulls out narrow-band interfering noise within a wide-band frequency signal without the use of explicit multiplication operations or specific multiplication hardware support. According to one embodiment of the invention, only addition operations are required. Furthermore, the system adaptively adjusts to time varying frequency signals and will adjust its nulling frequency depending on the value of the undesired frequency.

It will be recognized by those skilled in the art that the digital PLL 808 will lock onto a single, large amplitude interference signal, so long as the narrower band interference signal has a larger amplitude than the spread spectrum signal. The interference attenuator 100, 300, 400 attenuates this one interference signal. To attenuate more than one signal, interference attenuators 100, 300, 400 can be concatenated, such that a first interference attenuator attenuates the primary interferer, and a second interference attenuator 100, 300, 400 attenuates the output of the first attenuator. To attenuate even more signals, additional interference attenuators could be used.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method for processing a composite signal including a desired spread spectrum signal and an undesired narrow-band interfering signal having a center frequency, the method comprising:
determining the center frequency of the interfering signal;
shifting the composite signal lower in frequency by an amount equal to the center frequency of the interfering signal, thereby creating a shifted composite signal in which the center frequency of the interfering signal is zero;
filtering the shifted composite signal to remove the interfering signal and thus provide an interference-free shifted signal; and
reshifting the interference-free shifted signal higher in frequency by said amount equal to the center frequency of the interfering signal, thereby recovering the desired spread spectrum signal.

2. The method of claim 1, wherein determining the center frequency of the interfering signal comprises processing the composite signal by an adaptive digital phase locked loop to estimate the center frequency.

3. The method of claim 1, wherein determining the center frequency of the interfering signal comprises processing the composite signal by an adaptive digital phase locked loop which employs a CORDIC algorithm to estimate the center frequency.

4. The method of claim 1, wherein shifting the composite signal and reshifting the interference-free shifted signal comprise performing a complex frequency shift on the composite signal and on the interference-free shifted signal, respectively.

5. The method of claim 1, wherein shifting the composite signal and reshifting the interference-free shifted signal comprise performing CORDIC techniques.

6. The method of claim 1, wherein filtering the shifted composite signal comprises processing the shifted composite signal through a fixed FIR filter response.

7. The method of claim 1, wherein determining the center frequency of the interfering signal comprises filtering an output of a digital phase locked loop with an M-order COMB low-pass FIR filter.

8. The method of claim 1, wherein the determining, shifting, filtering, and reshifting are each performed through techniques that do not require any multiplications.

9. An apparatus for processing a composite signal including a desired spread spectrum signal and an undesired narrow-band interfering signal having a center frequency, the apparatus comprising:
a frequency-detector for determining a frequency of the interfering signal;
a first shifter coupled to the frequencydetector and coupled to the composite signal for shifting the frequency of the composite signal from a first frequency range, the frequency shifter shifting the composite signal by an amount determined from the frequency of the interfering signal, thereby creating a shifted composite signal in which the interfering signal is at a predetermined frequency;
a filter coupled to the first shifter for attenuating signals near the predetermined frequency, the filter to filter out the shifted composite signal to remove the interfering signal and thus provide an interference-attenuated shifted signal; and
a second shifter coupled to the frequency detector and the filter, the second shifter for shifting the interference-attenuated shifted signal by said amount determined from the frequency of the interfering signal, thereby returning the desired spread spectrum signal to the first frequency range.

10. The apparatus of claim 9, wherein the frequency detector comprises an adaptive digital phase locked loop.

11. The apparatus of claim 9, wherein the frequency detector comprises an adaptive digital phase locked loop including a vector rotation element which employs a CORDIC algorithm.

12. The apparatus of claim 9, wherein the first and second shifting elements are arranged to perform a complex frequency shift on the composite signal and on the interference-free shifted signal, respectively.

13. The apparatus of claim 9, wherein the first and second shifters comprise vector rotation elements which employ a CORDIC algorithm.

14. The apparatus of claim 9, wherein the filter includes a fixed FIR filter response.

15. The apparatus of claim 9, further comprising an M-order COMB low-pass FIR filter coupled to the frequency-determining element for filtering an output of the frequency-determining element.

16. The apparatus of claim 9, wherein the frequency-determining element, the first and second shifting elements, and the filter are arranged such that they do not require any multiplications.

17. The apparatus as of claim 9, wherein the frequency detector detects the center frequency of the interference signal.

18. The apparatus of claim 9, wherein the filter comprises a DC notch filter.

19. A wireless communication device receiving and processing a composite signal including a desired spread spectrum signal and an undesired interfering signal having a narrower band width than the spread spectrum signal, the receiver comprising:
an antenna for receiving a signal;
receiver front-end circuitry coupled to the antenna and down-converting the received signal to the composite signal;
an analog-to-digital converter for converting the output of the receiver front end circuitry to a digital signal; and
a circuit for removing the undesired interference signal coupled to the receiver front end, the circuit comprising:
a frequency detector to determine a characteristic frequency of the interfering signal;
a first shifter coupled to the frequency detector and coupled to the composite signal for shifting the composite signal by an amount corresponding to the characteristic frequency of the interfering signal, thereby creating a shifted composite signal in which the frequency of the interfering signal is at a predetermined value;
a filter coupled to the first shifter for filtering the shifted composite signal to remove the interfering signal and outputting a filtered composite signal with the interfering signal attenuated; and
a second shifter coupled to the frequency detector and coupled to the filter for shifting the filtered composite signal in frequency by said amount corresponding to the characteristic frequency of the interfering signal, thereby returning the desired spread spectrum signal to the frequency range prior to filtering in the first filter; and
backend circuitry coupled to the output of the second shifter for further processing the desired spread spectrum signal.

20. The communication receiver of claim 19, wherein the frequency detector and the first and second shifters comprise vector rotation elements which employ a CORDIC algorithm.

21. The communication receiver of claim 19, wherein the first and second shifters are arranged to perform a complex frequency shift on the composite signal and on the interference-free shifted signal, respectively.

22. The communication receiver of claim 19, wherein the frequency detector, the first and second shifters, and the filter are do not require any multipliers.
